(19) United States
(12) Patent Application Publication
(10) Pub. No.: US 2006/0178831 A1
(43) Pub. Date: Aug. 10, 2006

(54) Methods, systems, and computer program products for representing object realtionships in a multidimensional space

(76) Inventors: Dimitris K. Agrafiotis, Downington, PA (US); Huafeng Xu, San Francisco, CA (US); Francis R. Salemme, Yardley, PA (US)

Correspondence Address: WILSON SONSINI GOODRICH & ROSATI, 650 PAGE MILL ROAD, PALO ALTO, CA, 94304-1050, US

(21) Appl. No.: 10/517,739

(22) PCT Filed: Jun. 12, 2003
(86) PCT No.: PCT/US03/18218

§ 371 Date: Aug. 3, 2005

Related U.S. Application Data
(60) Provisional application No. 60/387,953, filed on Jun. 13, 2002.

(51) Int. Cl. G06F 19/00

(52) U.S. Cl. 702/16; 702/19

(57) ABSTRACT

Methods, systems and computer program products for mapping is a set of related objects into a multidimensional space. The mapping is carried out using an iterative (e.g., pairwise) refinement strategy that attempts to ensure that the distances of the objects on the map satisfy a supplied set of upper and lower bounds. In a preferred embodiment, these upper and lower bounds are derived from a supplied set of relationships (similarities, dissimilarities, or proximities) between the objects. In another preferred embodiment, these distance bounds are chosen to preserve local relationships between neighboring objects while maintaining minimum separation between remote objects.

### BACKGROUND OF THE INVENTION

1. Field of the Invention

The present invention relates generally to data analysis and, more particularly, to methods, systems, and computer program products for representing object relationships in a multidimensional space.

2. Related Art

Extracting the minimum number of independent variables that can fully describe a set of experimental observations is a problem of central importance in science. Most physical processes produce highly correlated inputs, leading to observations that lie on or close to a smooth low-dimensional manifold.

Since the dimensionality and nonlinear geometry of that manifold is often embodied in the similarities between the data points, a common approach is to embed the data in a low-dimensional space that best preserves these similarities, in the hope that the intrinsic structure of the system will be reflected in the resulting map. See Borg, I. & Groenen, P. J. F., “Modem Multidimensional Scaling: Theory and Applications,” (Springer, N.Y., 1997), incorporated herein by reference in its entirety. However, conventional similarity measures such as the Euclidean distance tend to underestimate the proximity of points on a, nonlinear manifold, and lead to erroneous embeddings.

To remedy this problem, a well known method known as ISOMAP, discussed in Tenenbaum, J., B., de Silva, V., and Langford, J., C., “A Global Geometric Framework for Nonlinear Dimensionality Reduction,” Science 290, 2319-2323 (2000), incorporated herein by reference in its entirety, substitutes an estimated geodesic distance for the conventional Euclidean distance, and uses classical multidimensional scaling (NDS) to find the optimum low-dimensional configuration. Although it has been shown that, in the limit of infinite training samples, ISOMAP recovers the true dimensionality and geometric structure of the data if it belongs to a certain class of Euclidean manifolds, the proof is of little practical use since the at least quadratic complexity of the embedding procedure precludes its use with large data sets.

A similar scaling problem plagues locally linear embedding (LLE), a related approach that produces globally ordered maps by constructing locally linear relationships between the data points. LLE is discussed in Roweis and Saul, “Nonlinear. Dimensionality Reduction by Locally Linear Embedding,” Science 290, 2323-2326 (2000), incorporated herein by reference in its entirety.

What is needed is an improved method, system, and computer program product for extracting the minimum number of independent variables that can fully describe a data set. More specifically, what is needed is an improved method, system, and computer program product for mapping a set of objects related to each other by a set of relationships into a multidimensional space in a way that preserves the intrinsic structure of these relationships.

### SUMMARY OF THE INVENTION

The present invention is directed to a self-organizing method for embedding a set of related observations into an n dimensional space that preserves the intrinsic dimensionality and metric structure of the data. The invention is referred to herein as stochastic proximity embedding (SPE). The embedding is carried out using an iterative (e.g., pairwise) refinement strategy that attempts to preserve local geometry while maintaining a minimum separation between distant objects. In effect, the invention views the proximities between remote objects as lower bounds of their true geodesic distances, and uses them as a means to impose global structure.

The method includes:
(1) specifying a set of bounds for one or more associated relationships;
(2) assigning initial coordinates to the objects on an n dimensional map;
(3) selecting a pair of objects;
(4) computing a distance d between said selected objects on the n dimensional map;
(5) comparing said distance d between said selected objects on the n dimensional map to the bounds of their associated relationship r;
(6) adjusting the coordinates of said selected objects on the n dimensional map so that said distance d of said selected objects on the n dimensional map falls closer within said bounds of said corresponding relationship r, if said distance d between said selected objects on the n dimensional map falls outside said bounds of said corresponding relationship r;
(7) repeating steps (3) through (6) for additional pairs of objects; and
(8) outputting the coordinates of one or more objects on the map.

Additional features and advantages of the invention will be set forth in the description that follows. Yet further features and advantages will be apparent to a person skilled in the art based on the description set forth herein or may be learned by practice of the invention. The advantages of the invention will be realized and attained by the structure particularly pointed out in the written description and claims hereof as well as the appended drawings.

It is to be understood that both the foregoing summary and the following detailed description are exemplary and explanatory and are intended to provide further explanation of the invention as claimed.

### BRIEF DESCRIPTION OF THE DRAWINGS/FIGURES

The present invention will be described with reference to the accompanying drawings, wherein like reference numbers indicate identical or functionally similar elements. Also, the leftmost digit(s) of the reference numbers identify the drawings in which the associated elements are first introduced.

FIG. 1A illustrates a Swiss roll data set in 3-dimensional space.

FIG. 1B illustrates a 2-dimensional embedding of the Swiss roll data set obtained by SPE.

FIG. 1C illustrates the final stress of embeddings of the Swiss roll data set obtained by SPE and MDS as a function of embedding dimensionality.

FIG. 1D illustrates the final stress of 2-dimensional embeddings of the Swiss roll data set obtained by SPE as a function of simulation length for four data sets containing 10³, 10⁴, 10⁵ and 10⁶ points.

FIG. 2A illustrates a 2-dimensional stochastic proximity embedding of 1,000 conformations of methylpropylether, C₁C₂C₃O₄C₅, generated by a distance geometry algorithm and compared by RMSD.

FIG. 2B illustrates the final stress of embeddings of 1,000 methylpropylether conformations obtained by SPE and MDS as a function of embedding dimensionality.

FIG. 3A illustrates a 2-dimensional embedding of the diamine combinatorial library obtained by SPE.

FIG. 3B illustrates the final stress of embeddings of the diamine combinatorial library obtained by SPE and MDS as a function of embedding dimensionality.

FIG. 3C illustrates the final stress of 2-dimensional embeddings of the diamine combinatorial library obtained by SPE as a function of simulation length for four data sets containing 10³, 10⁴, 10⁵ and 10⁶ compounds.

FIG. 4 is a process flowchart 400 for implementing the SPE method.

FIG. 5 is a block diagram of an example computer system on which the present invention can be implemented.

### DETAILED DESCRIPTION OF THE INVENTION

Introduction

Modem science confronts us with massive amounts of data, such as expression profiles of thousands of human genes, multimedia documents, subjective judgements on consumer products or political candidates, trade indices, global climate patterns, etc. These data are often highly structured, but that structure is hidden in a complex set of relationships or high-dimensional abstractions.

The present invention is directed to a self-organizing method for embedding a set of related observations into a low-dimensional space that preserves the intrinsic dimensionality and metric structure of the data. The invention is referred to herein as stochastic proximity embedding (SPE). The embedding is carried out using an iterative (e.g., pairwise) refinement strategy that attempts to preserve local geometry while maintaining a minimum separation between distant objects. In effect, the method views the proximities between remote objects as lower bounds of their true geodesic distances, and uses them as a means to impose global structure.

Unlike previous approaches, the present invention reveals the underlying geometry of the manifold without intensive nearest neighbour or shortest-path computations, and can reproduce the true geodesic distances of the data points in the low-dimensional embedding without requiring that these distances be estimated from the data sample. The invention scales linearly with the number of points, and can be applied to very large data sets that are intractable by conventional embedding procedures.

The SPE algorithm utilizes the fact that the geodesic distance is always greater than or equal to the input proximity. Similar to ISOMAP, described above, the present invention assumes that the input proximity provides a reasonable approximation of the true geodesic distance when the points are relatively close, which is generally true if the local curvature of the manifold is not too large. Unlike ISOMAP, however, the present invention circumvents the calculation of approximate geodesic distances between remote points, and only requires that their distances on the low-dimensional map do not fall below their respective proximities.

Stochastic Proximity Embedding (SPE)

The embedding is carried out by minimizing an error function such as the following stress function:

$$E = {\sum }_{i < j} \frac{f ( {d}_{ij} , {r}_{ij} )}{{r}_{ij}} / {\sum }_{i < j} {r}_{ij} ,$$

where:
rᵢⱼ is the input proximity between the i-th and j-th points;
dᵢⱼ is their Euclidean distance in the low-dimensional space;
r_{c} is the neighbourhood radius; and
ƒ(dᵢⱼ, rᵢⱼ) is the pairwise stress function defined as:
   ƒ(dᵢⱼ, rᵢⱼ)=(dᵢⱼ−rᵢⱼ)² if rᵢⱼ≦r_{c} or rᵢⱼ>r_{c} and dᵢⱼ<rᵢⱼ, and
   ƒ(dᵢⱼ, rᵢⱼ)=0 if rᵢⱼ>r_{c} and dᵢⱼ≧rᵢⱼ.

The stress function is minimized using a self-organizing algorithm that attempts to bring each individual term ƒ(dᵢⱼ, rᵢⱼ) rapidly to zero. The method starts with an initial configuration and iteratively refines it by repeatedly selecting two points at random, and adjusting their coordinates in a way that reduces their pairwise stress ƒ(dᵢⱼ, rᵢⱼ).

The correction is proportional to the disparity:

$$λ \frac{\vert {r}_{ij} - {d}_{ij} \vert}{{d}_{ij}} ,$$

where λ is a learning rate parameter that decreases during the course of the refinement in order to avoid oscillatory behaviour. If rᵢⱼ>r_{c} and dᵢⱼ≦rᵢⱼ, i.e., if the points are non-local and their distance on the map is already greater than their proximity rᵢⱼ, their coordinates remain unchanged.

In a preferred embodiment, the intrinsic dimensionality of the manifold is revealed by embedding the data in spaces of decreasing dimensions, and identifying the point at which the stress effectively vanishes.

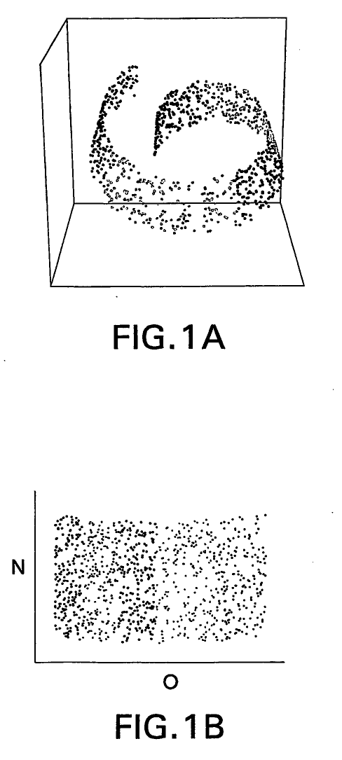

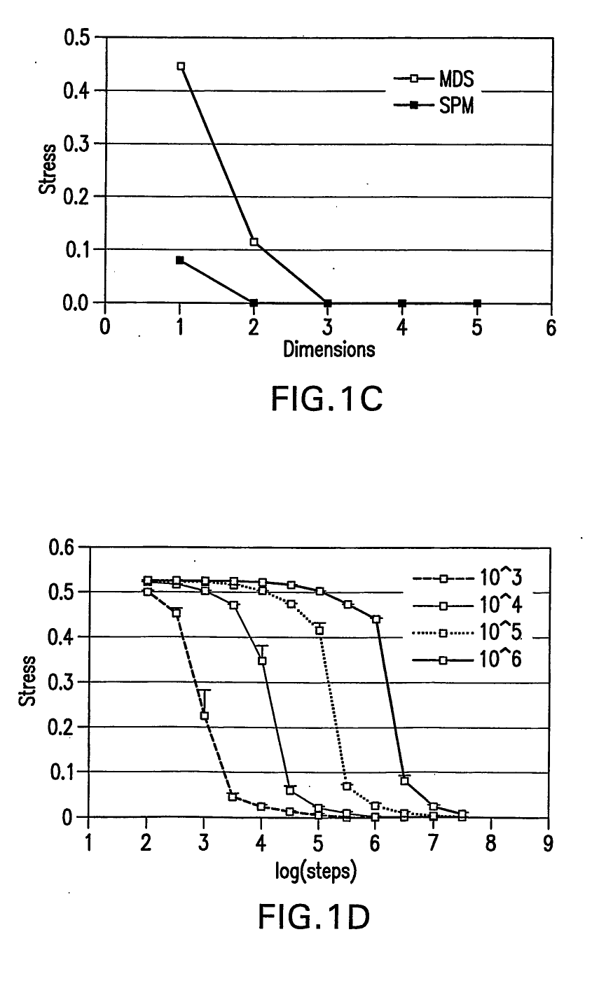

When applied to the Swiss roll, SPE reliably uncovered the true dimensionality of 2. As discussed below with reference to FIGS. 1A through 1D, the distances of the points on the 2-dimensional map matched the true, analytically derived geodesic distances with a correlation coefficient of 0.9999, indicating a virtually perfect embedding.

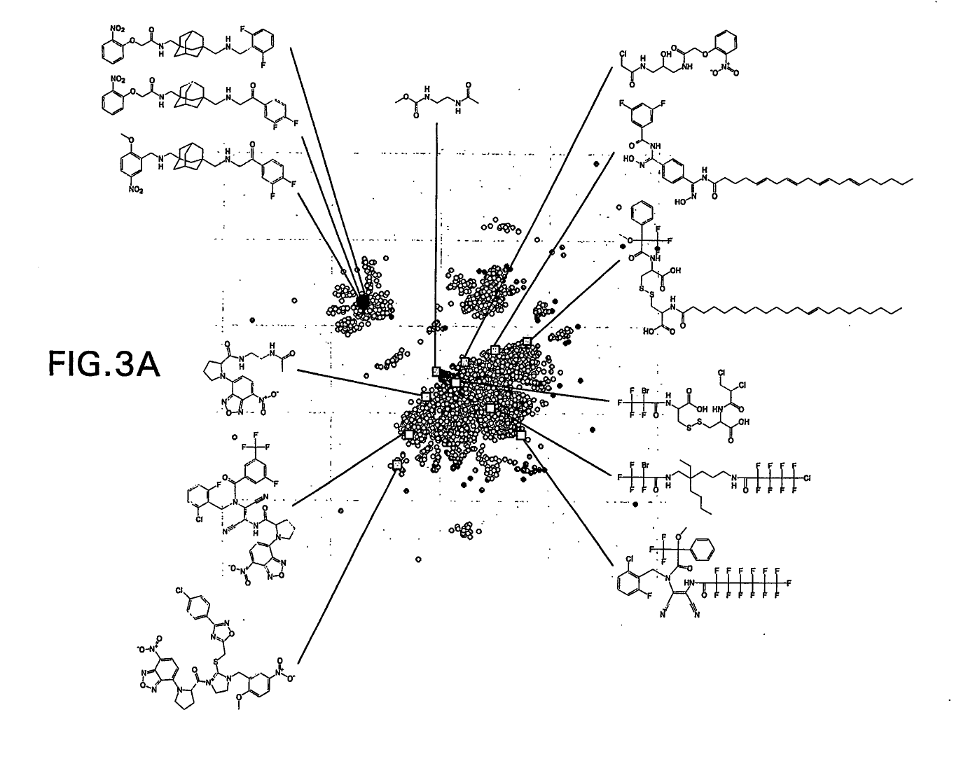

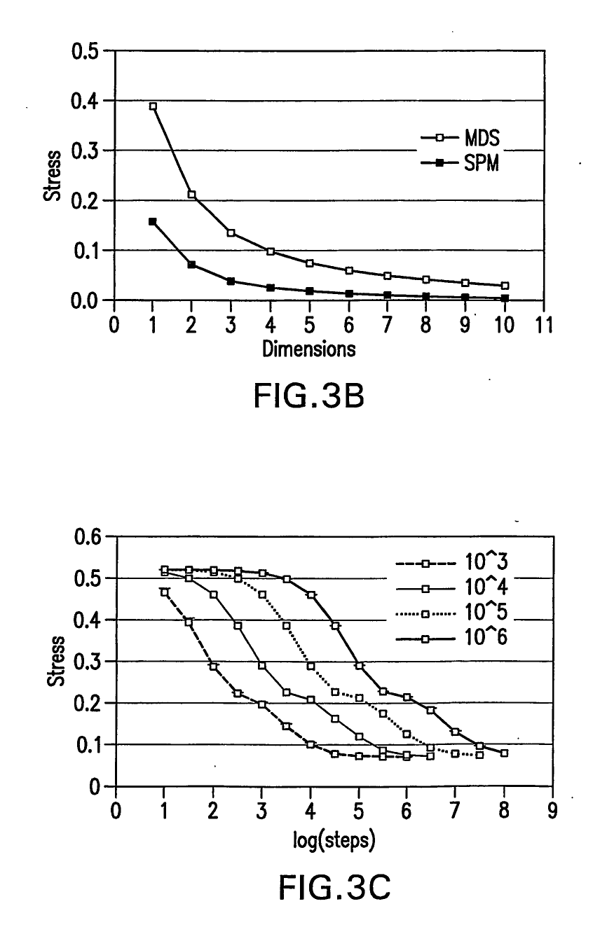

FIGS. 1A through 1D illustrate a stochastic proximity embedding of the Swiss roll data set. FIG. 1A illustrates original data in 3-dimensional space. FIG. 1B illustrates 2-dimensional embedding obtained by SPE. FIG. 1C illustrates a final stress obtained by SPE (mean and standard deviation over 30 independent runs—the latter is too small and therefore barely visible) and MDS as a function of embedding dimensionality. FIG. 1D illustrates a final stress of 2-dimensional embeddings obtained by SPE (mean and standard deviation over 30 independent runs) as a function of simulation length for four data sets containing 10³, 10⁴, 10⁵ and 10⁶ points. FIG. 1C, along with FIG. 3D, discussed below, demonstrates the linear scaling of SPE—a 10-fold increase in sample size results in an approximately 10-fold increase in the number of refinement steps that are required to achieve a comparable stress.

Similarly, the method was able to detect the intrinsic 2-dimensional structure of an ensemble of conformations of methylpropylether compared using the root mean square deviation (RMSD). The coordinate axes on the resulting map correlate very strongly with the molecule's true conformational degrees of freedom, revealing regions of conformational space that are inaccessible due to steric hindrance.

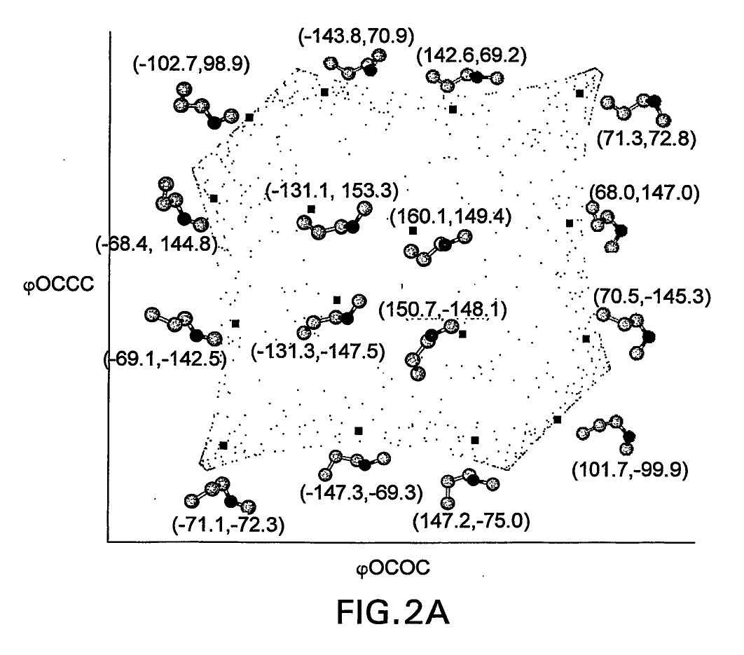

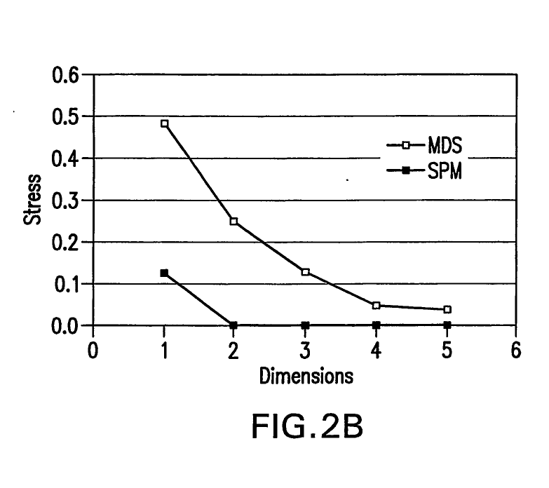

For example, FIGS. 2A and 2B illustrate stochastic proximity embedding of 1,000 conformations of methylpropylether, C₁C₂C₃O₄C₅, generated by a distance geometry algorithm and compared by RMSD. FIG. 2A illustrates 2-dimensional embedding obtained by SPE. Representative conformations are shown next to highlighted points in different parts of the map, along with the corresponding torsional angles, σC₂C₃O₄C₅ and (σC₁C₂C₃C₄, in parentheses. The horizontal and vertical directions represent rotation around the C₃-O₄ and C₂-C₃ bonds, respectively. The unoccupied upper-left and bottom-right corners represent conformations that are inaccessible because of the steric hindrance between the two terminal carbon atoms C₁ and C₅. FIG. 2B illustrates final stress obtained by SPE (mean and standard deviation over 30 independent runs) and MDS as a function of embedding dimensionality.

SPE can also produce meaningful low-dimensional representations of more complex data sets that do not have a clear manifold geometry. The embedding of the combinatorial library illustrated in FIGS. 3A through 3C shows that the method is able to preserve local neighbourhoods of closely related compounds, while maintaining a chemically meaningful global structure.

For example, FIGS. 3A through 3C illustrate stochastic proximity embedding of a diamine combinatorial library. FIG. 3A illustrates 2-dimensional embedding obtained by SPE. FIG. 3B illustrates final stress obtained by SPE (mean and standard deviation over 30 independent runs) and MDS as a function of embedding dimensionality. FIG. 3C illustrates final stress of 2-dimensional embeddings obtained by SPE (mean and standard deviation over 30 independent runs) as a function of simulation length for four data sets containing 10³, 10⁴, 10⁵ and 10⁶ compounds.

Although the intrinsic dimensionality of this data set is substantially higher than 2, the 2-dimensional map exhibits global order and continuity, as manifested by the dominant role of molecular weight, and the presence of variation patterns that correspond to chemically distinguishing features such as chain length, ring structure, and halogen content. See Agrafiotis, D. K, Lobanov, V. S., and Salemme, F. R., “Combinatorial Informatics in the Post-Genornics Era,” Nature Reviews Drug Discovery 1, 337-346 (2002), incorporated herein by reference in its entirety.

Although SPE does not necessarily offer the global optimality guarantees of ISOMAP or LLE, it works very well in practice. For example, as illustrated by the variances in FIG. 1C and FIG. 2B, the method converges reliably to the global minimum when the data is embedded in a space of the intrinsic dimensionality (and to a low-stress configuration in fewer dimensions), regardless of the starting configuration and initialization conditions. More importantly, when applied to data sets of increasing size drawn from the same probability distribution (and therefore expected to have comparable stress), the number of sampling steps required to reach a particular stress increases in linear fashion (FIG. 1D and FIG. 3C). The memory requirements of the method grow linearly as well, since the proximities can be computed on demand and need not be explicitly stored.

These characteristics are attributed to the stochastic nature of the refinement scheme and the vast redundancy of the distance matrix. Indeed, SPE is reminiscent of the stochastic approximation approach introduced by, Robbins, H. & Monroe, S., “A Stochastic Approximation Method,” Annals of Mathematical Statistics 22, 400-407 (1951), incorporated herein by reference in its entirety, and popularised by Rumelhart's back-propagation algorithm. See, Rumelhart, et al., “Learning Representations by Back-Propagating Errors,” Nature 323, 533-536 (1986), incorporated herein by reference in its entirety.

The direction of each pairwise refinement can be thought of as an instantaneous gradient—a stochastic approximation of the true gradient of the stress function. For sufficiently small numbers of λ, the average direction of these refinements approximates the direction of steepest descent. Unlike classical gradient minimization schemes, the use of stochastic gradients changes the effective error function in each step, and the method becomes less susceptible to local minima. In addition, the method exploits the redundancy in the inter-point distances through probability sampling. It is well known that the relative configuration of N points in a D-dimensional space can be fully described using only (N-D/2-1)/(D+1) distances, which is consistent with the linear complexity of SPE. Linear scaling in both time and memory is critical in modem data mining where large data sets abound.

As with ISOMAP and LLE, SPE depends on the choice of the neighbourhood radius r_{c}. If r_{c} is too large, the local neighbourhoods will include data points from other branches of the manifold, short-cutting them, and leading to substantial errors in the final embedding. If it is too small, it will lead to discontinuities, causing the manifold to fragment into a large number of disconnected clusters. An optimum threshold can be determined by examining the stability of the algorithm over a range of neighbourhood radii, as prescribed by Tenenbaum, J., B., “The ISOMAP Algorithm and Topological Stability,” Science 295, 7a (2002), incorporated herein by reference in its entirety.

By setting r_{c} to infinity, SPE can produce nonlinear maps that are essentially identical to those derived by classical MDS. In this case, the efficiency of the algorithm is even more impressive, since virtually all of the randomly chosen pairs result in “productive” work. In isometric SPE, once the general structure of the map has been established, the majority of pairwise comparisons do not result in any refinement, since most of the remote points are already separated beyond their lower bounds. This situation can be improved by caching and resampling neighbours during the course of the refinement.

SPE can be applied to substantially any problem where non-linearity complicates the use of conventional methods such as PCA and MDS, and where a sensible proximity measure, like the ones mentioned above, can be defined. The method is computationally inexpensive to implement, and can be used as a tool for exploratory data analysis and visualization. The coordinates produced by SPE can further be used as input to a parametric learner in order to derive an explicit mapping function between the observation and embedded spaces.

Because SPE fundamentally seeks an embedding that is consistent with a set of upper and lower distance bounds (the proximity of neighbouring points can be viewed as a degenerate distance range with identical lower and upper bounds), SPE can also be applied to other classes of distance geometry problems including conformational analysis, (See Spellmeyer, et al., “Conformational Analysis Using Distance Geometry Methods,” Journal of Molecular Graphics and Modelling 15, 18-36 (1997), incorporated herein by reference in its entirety), NMR structure determination, and protein structure prediction (See, Havel, T. F., and Kurt, W., “An Evaluation of the Combined Use of Nuclear Magnetic Resonance and Distance Geometry for the Determination of Protein Conformations in Solution,” Journal of Molecular Biology 182, 281-294 (1985), incorporated herein by reference in its entirety).

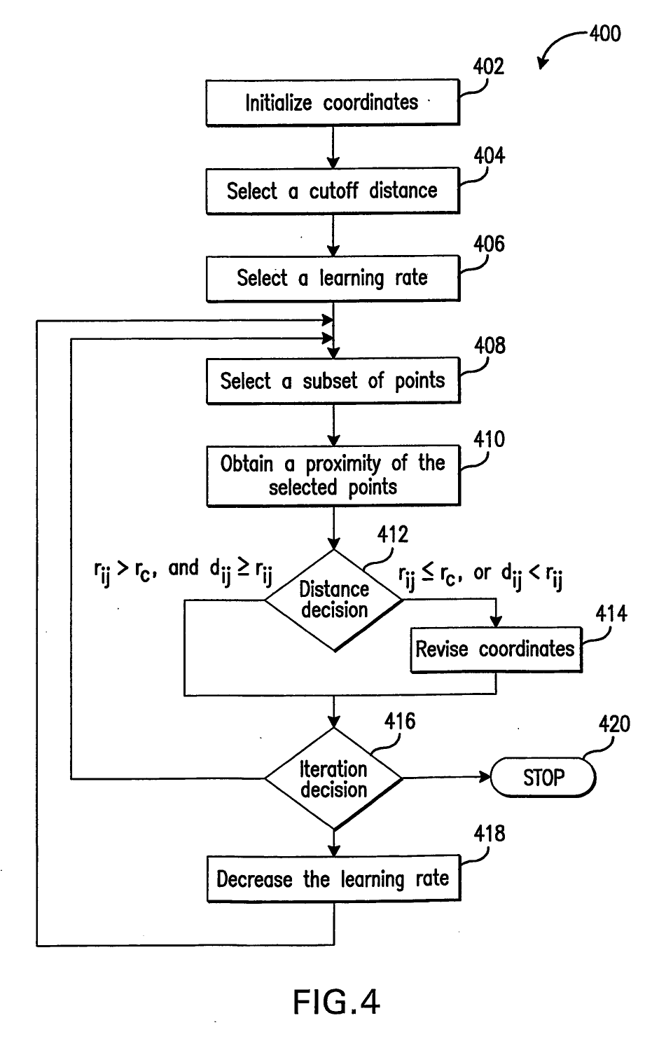

FIG. 4 is a process flowchart of an example method 400 for implementing the SPE algorithm. The process begins at step 402, which includes initializing the n dimensional coordinates of the N points, {yᵢₖ, =1,2, . . . , N, k=1,2, . . . , n}.

Step 404 includes selecting a cutoff distance r_{c}.

Step 406 includes selecting a learning rate λ>0.

Step 408 includes selecting a subset of points (e.g., two points, i and j).

The subset of points can be selected randomly.

Step 410 includes retrieving or evaluating the proximity of the selected subset of points in the input space, rᵢⱼ, and computing their Euclidean distance on the n dimensional map, dᵢⱼ=∥yᵢ−yⱼ∥.

In step 412, a determination is made. If rᵢⱼ≦r_{c} or if rᵢⱼ>r_{c} and dᵢⱼ<rᵢⱼ, processing proceeds to step 414, which includes updating or revising the coordinates yᵢₖ and yⱼₖ by:

$${y}_{ik} ← {y}_{ik} + λ \frac{1}{2} \frac{{r}_{ij} - {d}_{ij}}{{d}_{ij} + ɛ} ( {y}_{ik} - {y}_{jk} ) and$$

$${y}_{jk} ← {y}_{jk} + λ \frac{1}{2} \frac{{r}_{ij} - {d}_{ij}}{{d}_{ij} + ɛ} ( {y}_{jk} - {y}_{ik} )$$

where ε is a small number used to avoid division by zero.

Processing then proceeds to an iteration decision in step 416, which is described below.

Referring back to step 412, when rᵢⱼ>r_{c} and dᵢⱼ≧rᵢⱼ, the coordinates remain unchanged, and processing proceeds to step 416.

Steps 408 through 414 are repeated a desired number of times. Thus, in step 416, a determination is made as to whether steps 408 through 414 have been performed the desired number of times.

When steps 408 through 414 have been performed the desired number of times, processing proceeds to step 418, which includes decreasing the learning rate λ by a prescribed δλ. Processing then returns to step 408. Steps 408 through 414 are performed for another desired number of times at the reduced learning rate λ. This iterative process can be performed any number of times. The performance of steps 410 through 418, for different learning rates λ can be performed for a same number of iterations or for different numbers of iterations. After the desired number of cycles at different learning rates λ, the process is terminated in step 420.

In a study, embeddings were carried out using 100 refinement cycles, a linearly decreasing learning rate from 2.0 to 0.01, and a neighbourhood radius at the 10% threshold of all pairwise proximities in the sample, as determined by probability sampling. An initial learning rate λ>1 was used to induce faster unfolding of the random initial configurations. Alternative learning schedules may also be employed.

The data points for the Swiss roll were obtained by generating coordinate triplets {x=φ cos φ,y=φ sin φ,z}, where φ and z were random numbers in the intervals [5, 13] and [0,10], respectively.

The conformations of methylpropylether were generated using a distance geometry algorithm, which uses covalent constraints to establish a set of upper and lower interatomic distance bounds, and then attempts to generate conformations that are consistent with these bounds. See, Crippen, G. M., and Havel, T. F., “Distance Geometry and Molecular Conformation,” Research Studies Press, Somerset, UK, (1988), incorporated herein by reference in its entirety.

The proximity between conformations was measured by RMSD (for two conformations, the RMSD is defined as the minimum Euclidean distance between the vectors of atomic coordinates when the two conformations are superimposed through translations and rotations). RMSD is positive, symmetric, and satisfies the triangular inequality, and is therefore a valid proximity measure for SPE.

The 3-component virtual combinatorial library was generated by systematically attaching two aldehyde building blocks to a diamine core according to the reductive amination reaction. Each product was characterised by 117 computed topological indices, which were subsequently normalized in the interval [0,1] and decorrelated by principal component analysis to 26 orthogonal variables that accounted for 99% of the total variance in the data.

The Euclidean distance in the resulting 26-dimensional PC space was used as a proximity measure between two compounds. The PCA pre-processing step was used to eliminate strong linear correlations that are typical of graph-theoretic descriptors and thus accelerate proximity calculations. For the large data sets, the reported stress values were calculated by random sampling of 1,000,000 pairwise distances. These stochastic stress values have been shown to accurately approximate the true stress.

The present invention can be implemented in one or more computer systems capable of carrying out the functionality described herein. For example, and without limitation, the process flowchart 400, or portions thereof, can be implemented in a computer system.

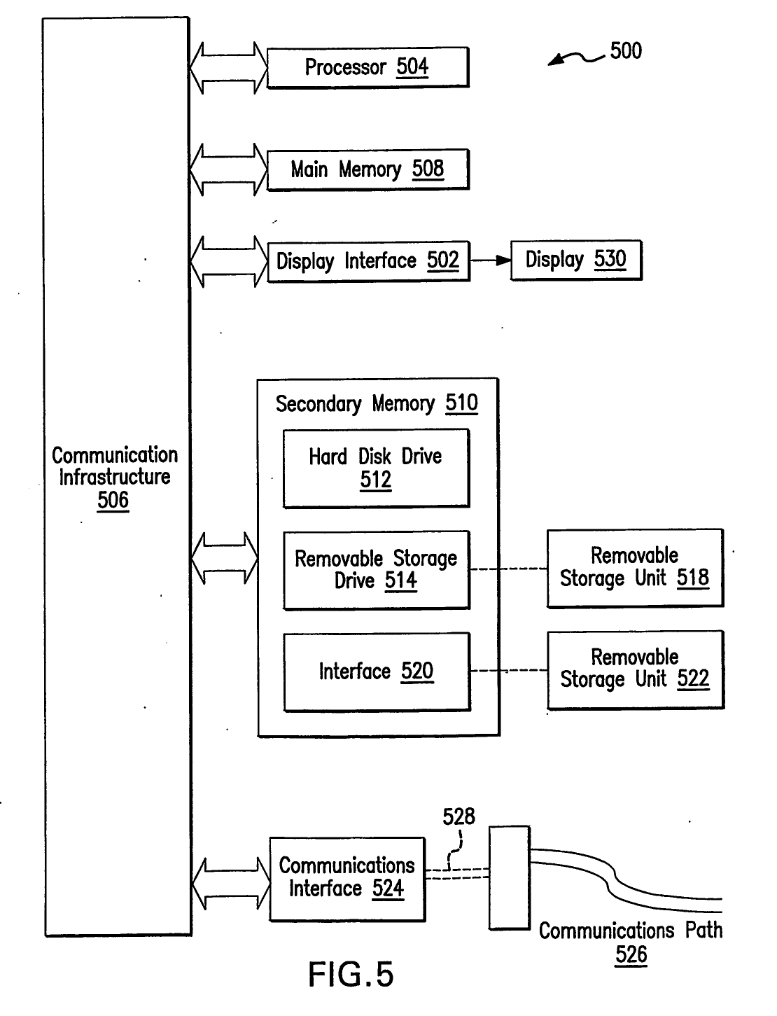

FIG. 5 illustrates an example computer system 500. Various software embodiments are described in terms of this example computer system 500.

After reading this description, it will be apparent to a person skilled in the relevant art(s) how to implement the invention using other computer systems and/or computer architectures.

The example computer system 500 includes one or more processors 504. Processor 504 is connected to a communication infrastructure 502.

Computer system 500 also includes a main memory 508, preferably random access memory (RAM).

Computer system 500 can also include a secondary memory 510, which can include, for example, a hard disk drive 512 and/or a removable storage drive 514, which can be a floppy disk drive, a magnetic tape drive, an optical disk drive, etc. Removable storage drive 514 reads from and/or writes to a removable storage unit 518 in a well known manner. Removable storage unit 518, represents a floppy disk, magnetic tape, optical disk, etc. which is read by and written to by removable storage drive 514. Removable storage unit 518 includes a computer usable storage medium having stored therein computer software and/or data.

In alternative embodiments, secondary memory 510 can include other devices that allow computer programs or other instructions to be loaded into computer system 500. Such devices can include, for example, a removable storage unit 522 and an interface 520. Examples of such can include a program cartridge and cartridge interface (such as that found in video game devices), a removable memory chip (such as an EPROM, or PROM) and associated socket, and other removable storage units 522 and interfaces 520 that allow software and data to be transferred from the removable storage unit 522 to computer system 500.

Computer system 500 can also include a communications interface 524, which allows software and data to be transferred between computer system 500 and external devices. Examples of communications interface 524 include, but are not limited to a modem, a network interface (such as an Ethernet card), a communications port, a PCMCIA slot and card, etc. Software and data transferred via communications interface 524 are in the form of signals 528, which can be electronic, electromagnetic, optical or other signals capable of being received by communications interface 524. These signals 528 are provided to communications interface 524 via a signal path 526. Signal path 526 carries signals 528 and can be implemented using wire or cable, fiber optics, a phone line, a cellular phone link, an RF link and other communications channels.

In this document, the terms “computer program medium” and “computer usable medium” are used to generally refer to media such as removable storage unit 518, a hard disk installed in hard disk drive 512, and signals 528. These computer program products are means for providing software to computer system 500.

Computer programs (also called computer control logic) are stored in main memory 508 and/or secondary memory 510. Computer programs can also be received via communications interface 524. Such computer programs, when executed, enable the computer system 500 to perform the features of the present invention as discussed herein. In particular, the computer programs, when executed, enable the processor(s) 504 to perform the features of the present invention. Accordingly, such computer programs represent controllers of the computer system 500.

In an embodiment where the invention is implemented using software, the software can be stored in a computer program product and loaded into computer system 500 using removable storage drive 514, hard disk drive 512 or communications interface 524. The control logic (software), when executed by the processor(s) 504, causes the processor(s) 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### CONCLUSION

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like and combinations thereof.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A computerized method for generating mapping coordinates for a set of objects, wherein two or more objects are related by associated pairwise relationships, the method comprising the steps of:
(1) specifying a set of bounds for one or more associated relationships;
(2) assigning initial coordinates to the objects on the map;
(3) selecting a pair of objects;
(4) computing a distance d between said selected objects on the map;
(5) comparing said distance d between said selected objects on the map to the bounds of their associated relationship r;
(6) adjusting the coordinates of said selected objects on the map so that said distance d of said selected objects on the map falls closer within said bounds of said corresponding relationship r, if said distance d between said selected objects on the map falls outside said bounds of said corresponding relationship r;
(7) repeating steps (3) through (6) for additional pairs of objects;
and
(8) outputting the coordinates of one or more objects on the map.

2. The method according to claim 1, wherein step (1) comprises the steps of:
(a) identifying a neighborhood radius r_{c};
(b) selecting a pair of objects;
(c) comparing the relationship r of said selected objects to said neighborhood radius r_{c};
(d) if said relationship r of said selected objects is less than or equal to said neighborhood radius r_{c}, assigning a lower bound and an upper bound of said relationship r of said selected objects equal to said neighborhood radius r_{c};
(e) if said relationship r of said selected objects is greater than said neighborhood radius r_{c}, defining a lower bound of said relationship r of said selected objects equal to said neighborhood radius r_{c}, and an upper bound of said relationship r of said selected objects equal to infinity; and
(f) repeating steps (a) through (e) for additional pairs of objects.

3. The method according to claim 1, wherein a pairwise relationship between two objects represents a similarity/dissimilarity between said objects.

4. The method according to claim 1, wherein a pairwise relationship between two objects represents a distance between said objects.

5. The method according to claim 1, wherein step (6) comprises the step of: adjusting the coordinates of said selected objects on the map by a correction factor so that said distance d of said selected objects on the map falls closer within said bounds of said corresponding relationship r, if said distance d between said selected objects on the map falls outside said bounds of said corresponding relationship r.

6. The method according to claim 5, further comprising the steps of repeating steps (3) through (7) for several correction factors.

7. The method according to claim 6, wherein the value of the correction factor is reduced after each repetition of steps (3) through (7).

8. The method according to claim 2, wherein steps (1) through (7) are repeated for several neighborhood radii r_{c}.
